(19) United States
(12) Patent Application Publication
(10) Pub. No.: US 2023/0341273 A1
(43) Pub. Date: Oct. 26, 2023

(54) SELECTIVELY ACTIVATABLE TIME TEMPERATURE INDICATORS

(71) Applicant: Freshpoint Quality Assurance Ltd., Nesher (IL)

(72) Inventors: Husein SALMAN, Golan Heights (IL); Elena TENETOV, Nesher (IL); Ziv ZEYTLIN, Migdal Haemek (IL)

(21) Appl. No.: 18/017,578

(22) PCT Filed: Jul. 21, 2021
(86) PCT No.: PCT/IL2021/050888

§ 371 Date: Jan. 23, 2023

(30) Foreign Application Priority Data
Jul. 23, 2020 (IL) 276263

(51) Int. Cl. G01K 3/04; B65D 79/02; G01K 11/12; G09F 3/00

(52) U.S. Cl. CPC G01K 3/04; B65D 79/02; G01K 11/12; G09F 3/0294

(57) ABSTRACT

A selectively activatable time-temperature indication (TTI) device, an article of manufacture comprising thereof and an activation method thereof. The TTI comprises a first element, a second element and a spacer configured to separate between the first element and the second element and is having a non-activated state and an activated state. TTI devices of this disclosure can be utilized to indicate the shelf life of a perishable good.

### TECHNOLOGICAL FIELD

The present disclosure concerns time-temperature indicators, more specifically activatable time-temperature indicators that can be activated upon demand.

### BACKGROUND ART

References considered to be relevant as background to the presently disclosed subject matter are listed below:
[1] WO 2006/048412
[2] WO 2008/083926
[3] WO 2009/156285
[4] WO 2013/186782

Acknowledgement of the above references herein is not to be inferred as meaning that these are in any way relevant to the patentability of the presently disclosed subject matter.

### BACKGROUND

Perishable goods, such as food products or pharmaceutical products, typically have a limited lifespan which is indicated to the consumer by a “best before date” label or printing applied onto the package of the perishable goods. However, the actual lifespan of such perishable goods depends mainly on appropriate storage conditions during distribution and storage, as various factors such as humidity, temperature, gas composition, etc., can accelerate deterioration of perishable goods. Hence, a “best before date” indication, which is based on the assumption of proper storage and transport conditions, is often inadequate to reflect the actual state of the perishable good over time.

Temperature abuse is the most frequently observed factor for deterioration of the perishable good, based on diverse physical, chemical, enzymatic and/or microbial processes. Therefore, various technologies have been developed to provide proper indication of the actual state of the perishable good, depending on the exposure to varying temperature conditions.

Time temperature indicators (TTIs) are devices that are developed for such purposes [1-4]. TTIs are based on at least one changeable observable physical/chemical property that progresses at a rate that is proportional to time, to temperature or to temperature and time. Such devices can, thus, provide an indication of the time-temperature history (full or partial) of their immediate surroundings when appropriately designed and calibrated. Change in visual physical properties (for example color) of such TTIs is a function of the time, and is temperature-dependent or time-temperature dependent, thus providing an active scale of “freshness” of the product to which it is attached, for example by comparing the color (or shade) of the TTI with a given comparative scale. TTIs can also be designed to provide a distinct “Yes” or “No” type indication regarding the time-temperature factor, and hence can provide a clear-cut indication to save further elaborate data inspection. Therefore, TTI technology can provide a simple tool for controlling perishable goods supply-chain.

TTIs labels are designed to be attached to the perishable good (or to a package thereof) and can provide real-time monitoring, typically in a simple visual manner, of the exposure history of the product to time-temperature, thereby providing indication of the product's freshness condition. Such labels are often based on a chemical reaction taking place between two or more reactants, the rate of the chemical reaction depending on temperature, and resulting in an observable visual change. The device is typically composed of two labels—one containing part of the reactants and the other containing the other part of the reactants, such that when the labels are brought into contact with one another, chemical reaction commences between the reactants (either immediately or after a certain controlled delay). In some arrangements, the TTI device can be provided in the form of two separate labels, and the user brings the two labels into contact with one another in order to initiate the reaction therebetween. In other arrangements, the two labels can be provided as an integral device, with a removable or breakable layer separating between the two labels; removal of the separation layer permits contacting the two labels to initiate the reaction.

### General Description

The present disclosure provides integral TTIs that are easily and simply activable, without the need to align two labels one against the other and/or to remove various separation layers in order to permit contact between two reactants. The TTI devices of the present disclosure are designed to be intuitive for operation by a single action.

Perishable goods are often packed in various packaging, and the shelf life or lifespan of such a perishable good significantly shortens once the package has been opened. The TTI devices of this disclosure can be utilized to indicate primary shelf life of the a perishable good (i.e. in a packaged state) and/or secondary shelf life (after package opening).

While the disclosure below refers to TTI indicators, it is to be understood that the same principles can be applied to also provide temperature indicators, time indicators, temperature threshold indicators, partial TTIs, etc.

In one of its aspects, this disclosure provides a time-temperature indication (TTI) device, that comprises a first element, a second element, and a spacer located between the first and second elements, the TTI device having a non-activated state and an activated state. The first element comprises a substrate film carrying a first reactant layer. The second element comprising a carrier film that has at least one pressable section, the pressable section carries a second reactant layer on at least a portion thereof. The second reactant layer is configured to adhere to the first reactant layer. The spacer is configured to separate between the first element and the second element and has a hollow activation zone that is substantially aligned with the pressable section.

In the non-activated state, at least a portion of the first reactant layer and the second reactant layer are non-contacted (as they are separated by the spacer); while in the activated state, the second reactant layer is adhered to the first reactant layer to enable a reaction between the first and second reactant layers that causes at least one substantially irreversible change in at least one physical property of the device as the reaction is designed such as to be indicative to time-temperature history of the device (and hence also of the perishable good to which the device can be attached). The device is switchable from the non-activated state to the activated state by application of pressure (or force) onto the pressable section to displace it, together with the second reactant layer that is attached thereto, within the hollow activation zone towards the first element and adhere the second reactant layer to the first reactant layer.

In other words, in the non-activated state, at least a segment of the first and second layers are prevented from contacting one another by the spacer. When a user wishes to activate the device, he/she presses onto the pressable section of the second element, thereby displacing the pressable section and the second reactant layer through the hollow activation zone towards the first reactant layer until the second reactant layer comes into contact with and adheres to the first reactant layer, thereby initiating the reaction between the first and second reactant layers in the contact region.

It is to be understood that the device can be activated by the user, by a dispenser that dispenses the TTI devices to be adhered on an article to be monitored, or even by an applicator that applies the TTI device onto the article to be monitored.

The term pressable section encompasses any section of a layer that can be pressed and thereby be displaced towards another layer. The displacement can be permanent, i.e., inducing plastic deformation of the pressable section and/or its respective layer, or non-permanent, i.e., inducing elastic deformation of the pressable section and/or its respective layer. It should be appreciated, that when pressing over the pressable section induces plastic deformation (caused by displacement) of the pressable section and/or its respective layer, the pressable section can remain at an intermediate state between its fully deformed and non-deformed states once pressing pressure is relieved.

In some embodiments said intermediate state corresponds to at least 10%, at times 20%, 30%, 40%, 50%, 60%, 70%, 80% or 90% deformation of the pressable section and/or its respective layer, with respect to the non-pressed state thereof.

The pressable section can be deformed or maintain its shape during pressing thereon and/or during displacement thereof. In some embodiments, said pressable section is limited to perform merely elastic deformation under a typical pressing load, i.e., a load applied by a typical human finger, e.g., 30N to 110N. In other embodiments said pressable section can be adapted to perform plastic deformation under a typical pressing load, i.e., a load applied by a typical human finger, e.g., 30N to 110N.

In some embodiments a pressable section can be included in any one of the carrier film, the first element, the first reactant layer, the second reactant layer and the substrate film.

It is to be understood that the term reactant used herein, unless specifically noted otherwise, is meant to refer to a single chemical entity or to a mixture or composition of two or more chemical entities.

In some embodiments, the rate of the reaction is temperature dependent. In other embodiments the rate of the reaction is both time and temperature dependent, meaning that the rate of the reaction changes with time after activation. Without wishing to be bound by theory, the TTI can provide various dependencies on time and temperature, depending on the nature of the reaction between the first and second reactants. For example, the TTI can provide a gradual change in at least one physical property; alternatively, a non-gradual change in at least one physical property can be provided (i.e. a TTI that has no apparent time-temperature evolution during a first part of its lifespan, while having a significant change during a second part of its lifespan), thus providing a relatively sharper change in properties close to the end of the TTI's lifespan. In some other embodiments, the reaction between the first and second reactants may occur at a given partial temperature range, thus providing indication only when exposed to said temperature range (partial history TTI), or over the entire relevant range of temperatures to be monitored (full history TTI). Hence, the device can provide an indication of partial or full time-temperature history of the device, either in a monotonic or non-monotonic way.

As noted, depending on the rate of reaction between the first and second reactants, some time may pass before the change in the at least one physical property is observable (or apparent to the user). Hence, in further embodiments, the TTI device can comprise an activation indication zone that provides the user with indication that the TTI device has been properly activated.

The reaction between the first reactant layer and the second reactant layer (or between a first reactant contained in the first reactant layer and a second reactant contained in the second reactant layer) causes a substantially irreversible change in at least one physical property of the TTI device. In some embodiments, the physical property is selected from at least one of color, transparency, electric conductivity, reflectance, volume, fluidity, etc.

In some embodiments, the pressable section of the carrier film may be plastically deformable, thus, once pressed, the carrier film maintains its deformation to hold the second reactant layer in contact with the first reactant layer.

In other embodiments, the pressable section of the carrier film is deformable such that it returns, at least partially, to its non-deformed/non-pressed state once the pressing pressure is relieved. In such embodiments, one or both of the first reactant layer and the second reactant layer is designed to be detachable from the substrate film and the carrier film, respectively, as to permit detachment of said first reactant layer and/or the second reactant layer from said substrate film and carrier film, respectively, after adherence of the second reactant layer to the first reactant layer. Due to this detachment, the first and second reactant layers remain adhered to one another after the pressable section returns to its non-deformed/non-pressed state, or any intermediate state between the fully deformed and non-deformed states, when pressure is released from the device.

According to other embodiments, at least a portion of the first element is also pressable or deformable, and said hollow activation zone is configured to accommodate displacement of at least a portion of the first reactant layer thereinto. In other words, according to some configurations, both the first and second elements can be pressed/deformed (in at least sections thereof) in order to oppositely displace the first reactant layer and the second reactant layer into the hollow activation zone.

According to some embodiments, the first reactant layer is detachable from the substrate film, such that adherence to the second reactant layer detaches at least a portion of the first reactant layer from the substrate film. For example, the first reactant layer can be attached to the substrate film by a first adhesive, while the second reactant layer can be composed of a second adhesive in which the second reactant is embedded or dispersed. When the first adhesive has a lower adhesion strength to the substrate than the adhesion strength of that of the second adhesive to the first reactant layer, a detachable portion of the first reactant layer will adhere to the second reactant layer, and as the adhesion strength of the second adhesive to the carrier film is stronger than that of the first adhesive to the substrate film, the detachable portion of the first reactant layer will adhere to the second reactant layer and detach from the substrate film, thus ensuring that the first and second reactant layers remain adhered to one another and to the pressable section when the pressable section substantially returns to its non-pressed state or any intermediate state between the fully deformed and non-deformed states.

The term adhesion strength denotes the interfacial strength between adhesive and the material to which it is attached.

It is to be noted that while, in some embodiments, the various layers and sub-layers are adhered one to the other, it is also contemplated within the scope of the present disclosure that at least some of the layers (and/or sub-layers) may be attached to one another by means other than adhesives, for example by welding or other bonding techniques, as long as the functionality of the device disclosed herein is maintained.

According to other embodiments, the second reactant is detachable from the carrier film, such that adherence to the first reactant layer detaches the second reactant layer from the carrier film when the pressable section returns to its non-pressed state or any intermediate state between the fully deformed and non-deformed states. For example, the second reactant layer can be attached to the carrier film by an intermediate adhesive, while the second reactant layer can be made of (or comprise) a second adhesive in which a second reactant is embedded or dispersed. When the intermediate adhesive has a lower adhesion strength to the carrier film than that of the second adhesive to the first reactant layer, the second reactant layer will adhere to the first reactant layer, and as the adhesion strength of the second adhesive to the first reactant layer is stronger than to the intermediate adhesive to the carrier film, the second reactant layer will attach to the first reactant layer and detach from the carrier film, thus ensuring that the second reactant layer remains adhered to the first reactant layer when the pressable section substantially returns its non-pressed state or any intermediate state between the fully deformed and non-deformed states.

According to further embodiments, a release layer may separate between detachable portions/layers and their carrying surfaces (e.g. the carrier film and/or the substrate film) that facilitates detachment of detachable portions/layers from their carrying surfaces. For example, presence of a release layer between the second reactant layer and the carrier film can facilitate detachment of the second reactant layer from the carrier film when the second adhesive has a higher adhesion strength to the first reactant layer than to the release layer. In some other embodiments, the carrier film can be constituted by such a release layer or can be coated with a coating functioning as a release layer.

In some embodiments, a release layer may be located between the first reactant layer and the substrate film, that facilitates detachment of the first reactive layer from the substrate film.

The term release layer refers to a layer having a surface that binds less effectively to an adhesive compared to the adhesive's binding to a target surface. The term also means to denote a coating functioning as a release layer; in other words, a layer that is coated by a material functioning to reduce adhesion strength of an adhesive thereto.

In some embodiments, the carrier layer is (or is coated by a suitable coating to function as) a release layer.

The release layer may, for example, be made of or coated by a silicon-based or fluorinated polymer, or can even be a siliconized or fluorinated surface or any other suitable surface.

In some embodiments, both the first reactive layer and the second reactive layer are associated, respectively, to the substrate film and the carrier film via release layers.

The substrate film of the first element can be made of any suitable material and have any desired shape or form. The substrate film can be flexible or rigid, may be substantially two-dimensional (a thin flat substrate) or a three-dimensional curved (non-flat) surface. The substrate film is typically made of a polymeric material, such as polysiloxanes, polyethylene (low-density polyethylene, medium-density polyethylene, high-density polyethylene, or linear low-density polyethylene), polypropylene (biaxially oriented film (BOPP), monoaxially oriented, or uniaxially oriented films), polyester, polyamide, copolyimide, polyimide, polyvinyl chloride (with or without a plasticizer), cellulose acetate, cellulose derivatives (e.g. cellophane), polytetrafluoroethylene (PTFE), vinyl fluoride, PVC (polyvinyl chloride), PVDF (polyvinylidene fluoride), PTFE (polytetrafluoroethylene or Teflon), polystyrene, phenol-formaldehyde resin, para-aramid fibers, etc.

The substrate film can be clear or opaque, colorless, colored (having any CIE-Lab color value) or printed. The substrate film may can be transparent, semitransparent, or hazed. In some embodiments, the substrate is (or can function as) a release layer for the first reactant layer; in other words, the substrate can be made of or coated by a material that binds less effectively to the first reactant layer compared to the binding between the first and second reactant layers. This enables the first reactant layer to detach from the substrate layer when the pressable section returns to its substantially non-pressed state after the second reactant layer comes into contact with and adheres to the first reactant layer.

In some embodiments, the first reactant layer may cover substantially the entire surface of the substrate layer. In other embodiments, the second reactant layer may cover substantially the entire surface of the pressable section that faces the first reactant layer. In some other embodiments, the second reactant layer covers one or more surface portions of the surface of the pressable section that faces the first reactant layer. The one or more surface portions may be of any size, shape and structure, the surface portions may be continuous or comprise of several non-continuous sub-portions on the surface, e.g. forming a pattern, a pictogram, signs, lettering, etc. As a mere non-limiting example, when the second reactant layer is in the form of lettering, reaction between the first and second reactant layers can occur only at the contact areas, thereby resulting in a visual indication in the form of appearance, disappearance or change in color or in the shape of letters.

The reaction between the first and second reactants in each of the surface portions may have the same rate (or same time-temperature dependency), or may be tailored to have different reaction rates such that the change (and/or rate of change) in each surface portion will be different than that in other surface portions. The reaction between the first and second reactants in each of the surface portions may have the same temperature sensitivity of the reaction rate, or may be tailored to have different temperature sensitivities of the reaction rates such that the change (and/or rate of change) in each surface portion will be different than that in other surface portions upon changing temperature.

The reaction between the first and second reactant layers can be any reaction that causes at least one physical substantially irreversible change in the device. The reaction can be selected from acid-base reaction, redox reaction, complexation, etching, dissolution, crystallization, phase change, acid-metal oxide reactions, acid-metal reactions, replacement reactions, base-metal oxide reactions, base-metal reactions, etc.

In some embodiments, the reaction between the first and second reactant layers is an etching reaction, i.e. one of the first and second reactant layers comprises an etchable reactant, while the other one of the first and second reactant layers comprises an etching reactant.

According to some embodiments, the first reactant layer comprises a metal-containing sub-layer, the metal constituting the first reactant (e.g. an etchable reactant); for example such a metal-containing sub-layer can be in the form of metal particles embedded in wax, metal particles embedded in phase-change material, metal particles embedded in polymeric matrix, or made of metallic ink. The metallic particles may be in the form of spheres having an average diameter ranging from 1-1000 nm (nanometers), preferably ranging from about 3 nm to about 1000 nm. Alternatively, the metallic particles may be in the form of discs, lamella or any other shape, typically 1-1000 nm thick and 0.01-100 microns wide.

In other embodiments, the metal-containing sub-layer (to be interchangeably referred to herein also as a metallic sub-layer) may be made of a metal (i.e. a continuous metal film). In other embodiments, the first reactant layer is constituted by a metalized polymeric film. The metalized polymeric film comprises a metallic film deposited atop a polymeric film, for example by physical vapor deposition (PVD). When first reactant layer comprises a metal sub-layer or is constituted by a metalized polymeric film, the thickness of the metal sub-layer (or the metal film coating the polymeric film) can range between about 5 Å (Angstrom) and about 1000 Å. The thickness of the metalized film can be, for example, 1 nm to 1 mm, and preferably from 5 nm to 500 μm.

The metal can be coated with oxides, sulfides or other metal complexes and salts, either through natural or synthetic coating processes. In other embodiments the metal can be coated with an organic layer that is destructible and/or penetrable by one or more components of the second reactant.

In some embodiments, the second reactant layer can comprise an etchant sub-layer which is constituted by an adhesive matrix into which an etchant is embedded or dispersed. In some other embodiments, the etchant sub-layer may be made of an adhesive matrix which constitutes said etchant. In some other embodiments, the second reactant layer can be constituted by an adhesive matrix comprising one or more etchants.

The etchant is typically selected to etch the metal component in the first reactant layer at a desired time or time-temperature dependent rate. In some embodiments, the etchant can be selected from phosphoric acid (H₃PO₄), phosphorus acid (H₃PO₃), hydrochloric acid (HCl), nitric acid (HNO₃), sulfuric acid (H₂SO₄), hydrofluoric acids (e.g. HF, HBF₄), polyphosphoric acid, pyrophosphoric acid, phosphonic acid, alkylphosphonic acid (and derivatives thereof), aryl sulfonic acids alkyl sulfonic acids (and derivatives thereof), Poulton's reagent (mixture of HCl_{(conc)} and HNO_{3(conc)}), heteropoly acids (such as phosphotungstic acid (PWA) and silicotungstic acid (SiWA)), basic solutions (e.g. KOH, NaOH, amines), ferric chloride (FeCl₃), copper sulfate (CuSO₄), copper chloride (CuCl₂), potassium ferricyanide (K₃(FeCN)₆), potassium permanganate solutions (for example KMnO₄ in basic water and a wetting agent), aqueous solutions of chromium (VI) oxide (1%), reagents solutions (such as HCl, FeCl₃ in H₂O or 95% ethanol; H₂O, HCl, ammonium persulfate; chromic acid, sodium sulfate, hydrochloric acid, water; H₃PO₄, carbitol (diethylene glycol monoethyl ether), boric acid, oxalic acid, HF, water; NaOH, NaF, water; tetramethyl ammonium hydroxide (TMAH, (CH₃)₄NOH) and KOH; water, ammonia and hydrogen peroxide (30%), sodium molybdate, HCl, ammonium bifluoride and water), and any mixture or combination thereof.

When the reaction between the first and second reactant layers is based on etching, the metal component (either in particulate form or as a film) of the first reactant layer is typically selected from aluminum, copper, silver, iron, magnesium, titanium, tin, chromium, zinc, nickel, and alloys of these metals. In some embodiments, the metal is aluminum. Without wishing to be bound by theory, the oxide layer naturally formed, or added on the surface of aluminum can substantially prevent the metal from further reacting with oxygen, moisture and other reactants that may be present in the atmosphere. In some embodiments, the metal layer is protected from such undesirable reactions with oxygen, moisture and alike materials, sometimes present in the atmosphere by coating it with a thin layer (e.g. a mono-layer) of long thiols, such as for example 1-n-octadecanethiol and/or disulfide, such as di-n-octadecyl disulfide, layer.

The first reactant layer can further comprise one or more destructible, permeable or semi-permeable barrier sub-layers, formed atop of the metal-containing sub-layer. Such permeable or semi-permeable sub-layer is designed to have a defined permeability to the second reactant (e.g. the etchant), thus can modify the rate and/or temperature sensitivity of the physical change in the TTI device. For example, the first reactant layer can be a metal (e.g. aluminum) that may be coated by an oxide (native oxide or an oxide of another metal) or a sulfide layer, and hence etching will typically commence only after dissolving, demolishing, removing or penetrating the coating before reaction between the metal and the etchant occurs, thus elongating the time required for the physical change to be observed. By another example, a semi-permeable sub-layer can elongate the time required for the second reactant to contact the first reactant (after the second reactant layer has adhered to the first reactant layer), thereby adjusting the rate of physical change in the TTI device that is applied onto perishable good that has a relatively long shelf-life or lifespan (pharmaceuticals for example). The barrier layer may also alter the temperature sensitivity of the rate of appearance of the physical change in the TTI device. Non-limiting examples of such permeable or semi-permeable sub-layer(s) may be cellulose derivatives (such as cellulose acetate butyrate), polyacrylates, polyepoxides, polyurethanes, polystyrenes, polyimidazoles, etc.

The destructible, permeable or semi-permeable barrier sub-layer(s) may have a uniform thickness or variable thickness across the surface of the first reactant layer, e.g. may have a gradually changing thickness or may have zones that differ in thickness from adjacent zones. Such differences in thickness of the barrier sub-layer(s) can permit different elongation periods of the reaction between the first and second reactants at different zones of the device. A similar effect can be obtained by utilizing different types barrier sub-layers in different zones across the surface of the first reactant layer, each type of barrier sub-layer providing different reaction elongation time.

As noted, the reaction between the first and second reactant layers causes one or more physical substantially irreversible changes in the TTI device. In some embodiments, this change is an observable change in the color of at least a portion of the device. This can be obtained by tailoring the reaction between the first and second reactant layers to produce reaction products of a distinct color. Alternatively, when the reaction is based on metal etching, the change in color can include change in light reflectance of the metal (for example turning from metallic sheen to a mat appearance). As the thickness of the metal layer or sub-layer in the first reactant layer decreases with progression of the etching reaction, the metal becomes increasingly light transmissive. Hence, the change in transparency of the metal layer or sub-layer can reveal any coloring, lettering, patterning, etc. that is obscured by the metal (in cases where the reaction products do not hinder light transmittance). Thus, in some embodiments, the first reactant layer further comprises a colored or printed indication sub-layer disposed between the substrate film and the metal-containing sub-layer. In other embodiments, the metallic sub-layer is a metalized polymeric film (i.e. a polymer film coated by a metal film), the polymer film being colored or being printed at a non-metalized surface thereof. In other embodiments, the metallic sub-layer is printed at a top and/or a bottom surface thereof. When the metal is etched and gradually becomes transparent due to reduction in its thickness, the color or printed indication is exposed to the user, serving as the physical change in the TTI device that provides the desired time-temperature history indication.

In some embodiments the observed physical change in the TTI device originates from more than one component of the TTI. For example, in some embodiments, as the metallic layer or sub-layer is etched away and thins, it changes its optical properties from substantially opaque metallic reflector to a semi-transparent black layer. In the latter, the observed color is a combination of the color of the semi-transparent thin metal layer and the color of the layer or layers residing underneath. At the end of the etching process, in cases where the etched metal produces colorless, substantially light transmissive products, the observed color is mostly the function of the color of the layer or layers residing underneath.

When the desired physical change in the TTI device is a visual change, at least some of the parts of the device need to permit the user to view the physical change. Thus, in some embodiments, the pressable section of the carrier film can be transparent, clear (i.e. having no color, or colored however clear as to permit light transmission therethrough), or semi-transparent.

In some arrangements, the physical change is a color change, and the user needs to compare the color formed in the reaction zone between the first and second reactant layers to a calibrated reference color in order to determine whether the device indicates that the perishable good to which it is attached is usable or not. Therefore, the TTI device can comprise one or more reference color zones. Such reference color zones will be typically formed adjacent the pressable section of the carrier film. By some embodiments, at least a portion of the carrier film, save the pressable section, comprises at least one of lettering, color blocks, color scale, pictograms, ornaments, etc.

In some embodiments, the carrier film is coated by a protective coating which seals the TTI device against environmental factors, such as moisture. In other embodiments, the TTI device is encapsulated by an encapsulation layer. In yet other embodiments, the topmost and bottom-most layers of the device are joined (e.g. through an adhesive or by welding) to form an enclosed TTI device that is isolated from various environmental conditions (e.g. moisture). In some other embodiments, the carrier layer and/or the substrate layer are also protective layers that prevent humidity and/or other environmental factors from effecting the device's operation. The protective layer(s) is typically transparent.

Some non-limiting examples of protective layer(s) may include water-sealing polyurethane, polyvinyl chloride, poly chlorotrifluoroethylene, bilayer laminates of polyvinyl chloride and poly chlorotrifluoroethylene, trilayer laminates of polyvinylchloride-polyethylene-polychlorotrifluoroethylene, glycolised polyethylene terephthalate (PETG), polychlorotrifluoroethylene (PCTFE), bilayer laminates of PETG and PCTFE, polyvinyl chloride with PCTFE (or with another suitable barrier film material), ethylene-vinyl alcohol copolymers (EVOH), trilayer laminations of PETG-PCTFE-EVOH, or any other suitable protective layers.

The spacer can be of any shape or form as to permit effective separation between the first and second elements, however still defining said hollow activation zone in a sufficient size as to permit displacement of the pressable section therein. The spacer can have any cross-sectional shape, can be uniform or non-uniform along its length dimension. In some embodiments, the spacer is in the form of a ring; in such embodiments, the spacer can have an internal circumference that is continuous and an external circumference that is interrupted, and vice versa. In other embodiments, the spacer can be structured of two or more elements, forming a continuous ring contour or non-continuous ring contour. The outer circumference of the ring can be of any shape, e.g. circular, oval, triangular, rectangular, polygonal, abstract, etc. The circumference of the hollow activation zone defined in the spacer can have any shape, independent of the shape of the outer circumference of the spacer. In some embodiments, the outer circumference of the spacer and the circumference of the hollow activation zone defined in the spacer have the same shape.

The spacer can be made of any suitable material, for example thermoplastic polymers (e.g. polypropylene, polyethylene, etc.), thermosetting polymers, elastomeric polymers, polymeric foams, rubber, metal or metalized polymeric film, UV curable material, UV curable ink, UV curable coating, solvent-based ink, water-based ink, etc.

In some embodiment, the spacer has a thickness ranging between about 5 and about 2000 μm, preferable 20-800 μm.

In order to permit application of the TTI device onto the perishable good or a package thereof, the first element can be configured for attachment to a surface of the perishable good or packaging. In some embodiments, the first element comprises a package-attaching adhesive layer, formed on an outer (product-facing) surface of the first element. The package-attaching adhesive layer can be coated with a removable release layer that can be removed by the user before attaching the TTI to the desired article or product.

In another aspect, there is provided a time-temperature indication (TTI) device, comprising: a first element comprising a substrate film carrying a first reactant layer, at least a portion of the first reactant layer being attached to the substrate film by a first adhesive; a second element comprising a carrier film having at least one flexible section, said flexible section carrying a second reactant layer on at least a portion thereof, the second reactant layer comprises a second adhesive in which a second reactant is embedded or dispersed, the second adhesive having a higher adhesion strength to the carrier film than the first adhesive to the substate film; a spacer configured to separate between the first element and the second element, and having an hollow activation zone substantially aligned with said at least one flexible section; the device having a non-activated state, in which the first reactant layer and the second reactant layer are non-contacted, and an activated state, in which said second reactant layer is adhered to at least a portion of said first reactant layer to enable a reaction therebetween that causes at least one substantially irreversible change in physical property of the device, said reaction being indicative to time-temperature history of the device, the device being switchable from the non-activated state to the activated state by application of force onto said flexible section to displace said flexible section within the hollow activation zone towards said first element, adhere the second reactant layer to the first reactant layer and detach said at least one portion of first reactant layer from the substrate film.

By another aspect, there is provided a time-temperature indication (TTI) device, comprising: a first element comprising a substrate film carrying a first reactant layer; a second element comprising a carrier film having at least one flexible section, a second reactant layer being adhered to said flexible section by an intermediate adhesive, the second reactant layer comprises a second adhesive in which a second reactant is embedded or dispersed, the second adhesive having a higher adhesion strength to the first reactant layer than to the intermediate adhesive; a spacer configured to separate between the first element and the second element, and having an hollow activation zone substantially aligned with said at least one flexible section; the device having a non-activated state, in which the first reactant layer and the second reactant layer are non-contacted, and an activated state, in which said second reactant layer is adhered to at least a portion of said first reactant layer to enable a reaction therebetween that causes at least one substantially irreversible change in physical property of the device, said reaction being indicative to time-temperature history of the device, the device being switchable from the non-activated state to the activated state by application of force onto said flexible section to displace said flexible section within the hollow activation zone towards said first element, adhere the second reactant layer to the first reactant layer and detach said second reactant layer from the carrier film.

While in the TTI devices described hereinabove the pressable section has been described to be a part of the second reactant layer, it is also contemplated that the pressable section may be a part of the first reactant layer.

Hence, by another aspect, there is provided a time-temperature indication (TTI) device, that comprises a first element, a second element, and a spacer located between the first and second elements, the TTI device having a non-activated state and an activated state. The first element comprises a substrate film carrying a first reactant layer over at least a pressable section thereof. The second element comprising a carrier film, carrying a second reactant layer on at least a portion thereof. The second reactant layer is configured to adhere to the first reactant layer. The spacer is configured to separate between the first element and the second element and has a hollow activation zone that is substantially aligned with the pressable section.

In the non-activated state, the first reactant layer and the second reactant layer are non-contacted (as they are separated by the spacer); while in the activated state, at least a portion of the second reactant layer is adhered to at least a portion of the first reactant layer to enable a reaction between the first and second reactant layers that causes at least one substantially irreversible change in at least one physical property of the device as the reaction is designed such as to be indicative to time-temperature history of the device (and hence also of the perishable good to which the device can be attached). The device is switchable from the non-activated state to the activated state by application of pressure (or force) onto the pressable section of the first reactant layer to displace it, within the hollow activation zone, towards the second element and adhere the first reactant layer to the second reactant layer.

In such embodiments, the first reactant layer is typically configured to be detachable from the pressable section once contacted and adhered to the second reactant layer.

By another aspect, this disclosure provides an indication device, comprising: a first element comprising a substrate film carrying a first reactant layer; a second element comprising a carrier film having at least one pressable section, said pressable section carrying a second reactant layer on at least a portion thereof, the second reactant layer configured to adhere to the first reactant layer; and a spacer configured to separate between the first element and the second element, and having a hollow activation zone substantially aligned with said at least one pressable section. The device has a non-activated state, in which the first reactant layer and the second reactant layer are non-contacted, and an activated state, in which said second reactant layer is adhered to at least a portion of said first reactant layer to enable a reaction therebetween that causes at least one substantially irreversible change in physical property of the device, the device being switchable from the non-activated state to the activated state by displacing the pressable section into the hollow activation zone towards said first element to cause adhering of the second reactant layer to the first reactant layer, the reaction being indicative to time-temperature history, temperature history, or time history of the device.

In some embodiments, one or both of the first reactant layer and the second reactant layer is detachable from the substrate film and the carrier film, respectively, to permit detachment of said first reactant layer and/or second reactant layer from said substrate film and carrier film, respectively, after adherence of the second reactant layer to the first reactant layer.

The TTI devices of this disclosure are typically integral devices, i.e. devices in which all of the elements and layers are provided to the user as a single unit device.

However, in other embodiments, the first element, the second element and the spacer can be separately provided (each alone or as a kit) to be assembled into a TTI device at a manufacturer's production site or by a user.

In some embodiments the TTI is a multi-step time-temperature indicator (TTI) comprising a multi-layer system having a substrate film carrying a first reactant layer; a second element comprising a carrier film having at least one pressable section, said pressable section carrying a second reactant layer on at least a portion thereof, the second reactant layer configured to adhere to the first reactant layer, and a barrier layer between said first and second reactant layer, wherein said barrier layer defines two or more segments within said multi-step TTI, each segment being distinguished from one another by any one or combination of thickness, composition and absence of barrier material. In some embodiments said two or more segments are selected such to provide a staircase time-temperature behavior.

In some embodiments said two or more segments provide a step-wise disappearance of one segment after another.

Another aspect of this disclosure provides an article of manufacture comprising one or more indication devices (e.g. TTIs) disclosed herein. The article can be a perishable good, a packaging of a perishable good, or any other article being or containing a temperature-sensitive and/or time-sensitive product or component.

The article of manufacture can comprise one or more packaging and a perishable good packaged in said packaging. In an article of manufacture, one or more TTI devices can be used, i.e. on the external packaging and/or on the internal packaging that contains the perishable good. Each of the TTI devices can reflect a different time-temperature dependent behavior to correlate to a primary or secondary shelf life of the perishable good. For example, one TTI device as described herein can be attached to an external cardboard box of a cosmetic cream and indicating the primary shelf life of the cream (namely, the shelf life of the product/packaging until the package is opened), and another TTI device attached to the internal glass or plastic container that holds the cosmetic cream, which is activable when the package is opened to indicate the secondary shelf life of the cosmetic cream. It should be noted that the two TTIs may also be in the form of a single device in which the secondary shelf life indicator is activated upon opening the package.

By another aspect, there is provided a method of activating a time-temperature indication (TTI) device, the method comprises displacing a pressable section of a carrier film of a second element of the TTI device towards a first reactant layer of a first element of the TTI device, the pressable section carrying a second reactant layer on at least a portion thereof which is configured to adhere to the first reactant layer, said displacing being through a hollow activation zone that is substantially aligned with said at least one pressable section and being defined in a spacer configured to separate between the first element and the second element, and said displacing causing adhering of the second reactant layer to the first reactant layer to activate a reaction therebetween, the reaction causing at least one substantially irreversible change in physical property of the device that is indicative to time-temperature history of the device.

In some embodiments, the method may further comprise displacing at least a portion of the first reactant layer into the hollow activation zone towards the second reactant layer. In such embodiments, displacing said portion of the first reactant layer into the hollow activation zone may be carried out concomitantly with pressing of the pressable section of the second element.

By a further aspect, there is provided a method of activating a time-temperature indication (TTI) device, the method comprises displacing a pressable section of a substrate film of a first element of the TTI device towards a second reactant layer of a second element of the TTI device, the pressable section carrying a first reactant layer on at least a portion thereof, the second reactant layer being configured to adhere to the first reactant layer, said displacing being through a hollow activation zone that is substantially aligned with said at least one pressable section and being defined in a spacer configured to separate between the first element and the second element, and said displacing causing adhering of the first reactant layer to the second reactant layer to activate a reaction therebetween, the reaction causing at least one substantially irreversible change in physical property of the device that is indicative to time-temperature history of the device.

According to some embodiments, the method further comprises displacing at least a portion of the second reactant layer into the hollow activation zone towards the first reactant layer. In such embodiments, displacing said portion of the second reactant layer into the hollow activation zone may be carried out concomitantly with pressing of the pressable section of the first element.

As used herein, the term about is meant to encompass deviation of ±15% from the specifically mentioned value of a parameter, such as temperature, pressure, size, etc.

Whenever a numerical range is indicated herein, it is meant to include any cited numeral (fractional or integral) within the indicated range. The phrases ranging/ranges between a first indicate number and a second indicate number and “ranging/ranges from” a first indicate number “to” a second indicate number are used herein interchangeably and are meant to include the first and second indicated numbers and all the fractional and integral numerals therebetween.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1C are schematic cross-sections of a TTI device according to an embodiment of this disclosure in a non-activated state (FIG. 1A), a transient position (FIG. 1B) and an activated state (FIG. 1C).

FIGS. 1D-1E are schematic cross-sections of variations of the TTI device according of FIGS. 1A-1C.

FIGS. 2A-2D are schematic top views of a TTI device according to an embodiment of this disclosure, as viewed by the user, at a non-activated state (FIG. 2A) and at various stages after activation (FIG. 2B-2C) until the device indicates that the perishable good is no longer usable (FIG. 2D).

FIGS. 3A-3D are schematic cross-sections of a TTI device according to a variation of the embodiment shown in FIGS. 1A-1C however also including a release layer between the second reactant layer and the carrier film—in a non-activated state (FIG. 3A), a transient position (FIG. 3B) and an activated state (FIGS. 3C-3D).

FIG. 3E is a schematic cross-sections of a variation of the TTI device according of FIGS. 3A-3D.

FIGS. 4A-4C are schematic cross-sections of a TTI device according to another embodiment of this disclosure in a non-activated state (FIG. 4A), a transient position (FIG. 4B) and an activated state (FIG. 4C).

FIGS. 5A-5C are schematic cross-sections of a TTI device according to a variation of the embodiment shown in FIGS. 4A-4C, however also including a release layer between the first reactant layer and the substrate film—in a non-activated state (FIG. 5A), a transient position (FIG. 5B) and an activated state (FIG. 5C).

FIGS. 6A-6B are schematic cross-sections of a TTI device according to another embodiment of this disclosure, with a plastically deformable pressable section, in a non-activated state (FIG. 6A) and an activated state (FIG. 6B).

FIGS. 7A-7B are schematic cross-sections of a TTI device according to another embodiment of this disclosure, in which both the first element and the second element have elastically deformable pressable sections, in a non-activated state (FIG. 7A) and an activated state (FIG. 7B).

FIGS. 8A-8B are schematic cross-sections of a TTI device according to another embodiment of this disclosure, similar to the embodiment of FIGS. 7A-7B, however also comprising a barrier membrane between the first and second elements—in a non-activated state (FIG. 8A) and an activated state (FIG. 8B).

FIGS. 9A-9B are schematic cross-sections of a TTI device according to another embodiment of this disclosure.

### DETAILED DESCRIPTION OF EMBODIMENTS

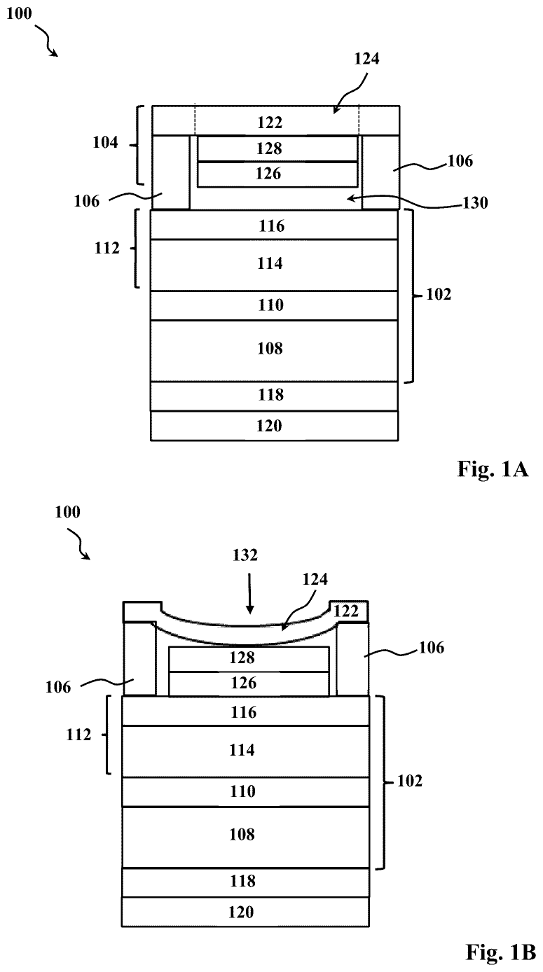

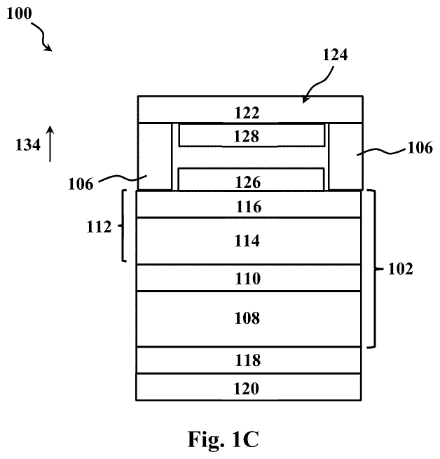

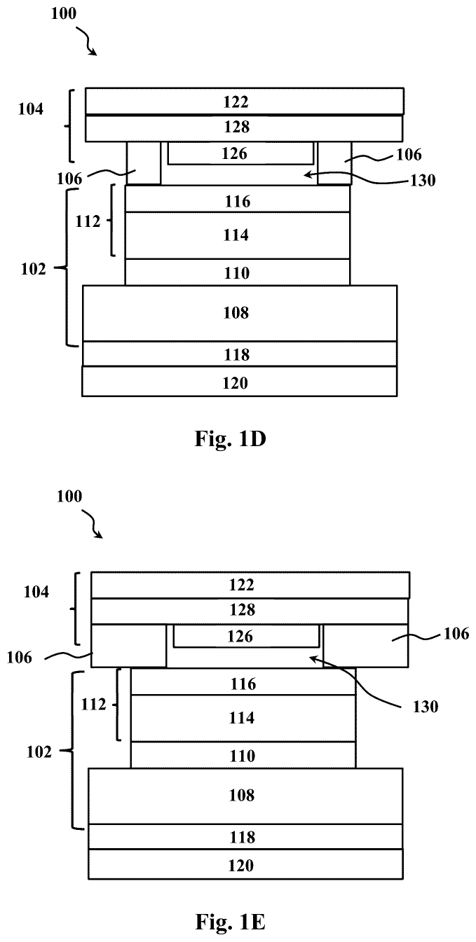

In FIGS. 1A-4B, some representations of TTI devices according to this disclosure will be exemplified. It is to be understood that the various element of the devices are schematically represented and are not indicative of any specific scale or size.

Further, in the examples herein, the reaction between the first and second reactant layers (or first and second reactants) is a metal-etching mechanism. However, it is to be understood that these are merely provided for exemplifications of the principles of operation of the TTI devices described herein, and any other suitable type of reaction between the first and second reactants are encompassed by this disclosure.

Turning first to FIGS. 1A-1C, shown is a schematic representation of a TTI device according to an embodiment of this disclosure, at its non-activated and activated operational states.

TTI device 100 comprises a first element 102 and a second element 104, separated by a spacer 106. First element 102 comprises a substrate film 108, onto which a first reactant layer 112 is adhered by a first adhesive 110. In this exemplified embodiment, first reactant layer 112 is a metalized polymeric film comprising a polymeric film 114 coated by a thin metal (e.g. aluminum) film 116. Metal film 116 constitutes the first reactant of this embodiment. In order to permit the device to be attached to a perishable good or to an article of manufacture, substrate 108 is typically coated by package-attaching adhesive layer 118, which is covered by a user-removable protective release layer 120. For attaching the TTI device to the perishable good, a user needs to peel release layer 120 of the package-attaching adhesive layer 118, and attach the device to the perishable good or to a packaging thereof.

Second element 104 comprises carrier film 122 that has a pressable section 124 (the pressable section being an integral part of the carrier film), the function of which will be described below. The pressable section 124 is attached to a second reactant layer 126, which comprises or consists of a second reactant. In this specific example, the second reactant is a pressure-sensitive adhesive matrix in which an etchant is dispersed. In this example, the second reactant layer 126 is attached to the carrier film 122 by an intermediate adhesive 128.

The spacer 106 has a hollow activation zone 130 that is aligned with the pressable section 124, and is sized to permit the displacement of the second reactant layer 126 therein when the pressable section 124 is deformed for activation of the device 100, as will now be explained.

In FIG. 1A, the TTI device 100 is at its non-activated state, in which the first reactant layer 102 and the second reactant layer 104 are non-contacted and separated by spacer 106.

For activating the TTI device, a user applies force onto the pressable section 124 (represented by arrow 132 in FIG. 1B), thereby pressing (or elastically deforming) the pressable section and causing the second reactant layer 126 to be displaced through hollow activation zone 130 towards the first reactant layer 112. Once the second reactant layer 126 and the first reactant layer 112 are contacted, the second reactant layer 126 (being or comprising an adhesive matrix) adheres to metal film 116 of the first reactant layer 112.

In this example, the second reactant layer 126 has lower adhesion strength to intermediate adhesive 128 than to first reactant layer 112 (more specifically to the metal film 116). Hence, once second reactant layer 126 is adhered to metal film 116, and pressable section 124 returns to its non-pressed state (in the direction of arrow 134), or any intermediate state between the fully deformed and non-deformed states, due to its elasticity, second reactant layer detaches from the intermediate adhesive 128 and remains adhered to metal film 116, and the TTI device is activated.

By this simple mechanism, a user merely needs to slightly press on the pressable section 124 to cause displacement of the second reactant layer 126 until it adheres to metal layer 116 in order to activate the device.

The contacting between the second reactant layer 126 and the first reactant layer 112 causes the beginning of a reaction between the etchant in the second reactant layer and metal film 116. The reaction rate depends on time and temperature, and hence can be used to indicate the time-temperature behavior of the perishable good to which the device is attached. In order to provide an easily identified indication, the device is designed such that the reaction between the first and second reactants (e.g. between the metal and the etchant) causes at least one irreversible physical change in the device.

For example, one or both of the substrate film 108 and the polymeric film 114 can be colored or printed with any type of marking (e.g. lettering, pattern, signs, etc.). As metal film 116 is etched, it becomes thinner Below a certain threshold thickness, metal film 116 becomes transparent, thereby exposing the color or printing of substrate film 108 and/or the polymeric film 114. The pressable section 124 is transparent, semi-transparent or clear, and hence a user can view the appearance of color or printing in the device following etching of metal film 116—providing an indication to the user of the usability of the perishable good.

A variation of this embodiment is shown in FIG. 1D. In the variation of FIG. 1D, intermediate adhesive 128 is also used to adhere the second element 104 to the spacer. Further, carrier film 122 and substrate film 108 are extended, such that their ends can be attached together in order to form a protective capsule around the active zone of the device, thus isolating the device from environmental effects (such as moisture). Extended carrier and substrate films 122 and 108, respectively, can be attached at their ends by any suitable method, e.g. adhering, welding, hot lamination, ultrasonic welding, etc. For such purposes, carrier and substrate films 122 and 108 may be made of or be coated by a material suitable for the desired attachment method.

In the variation of FIG. 1E, spacer 106 is extended and can be made of a material that is suitable for hot lamination, welding, ultrasonic lamination, etc., such that sealing of the active zone of the device can be obtained between extended substrate 108 and spacer 106.

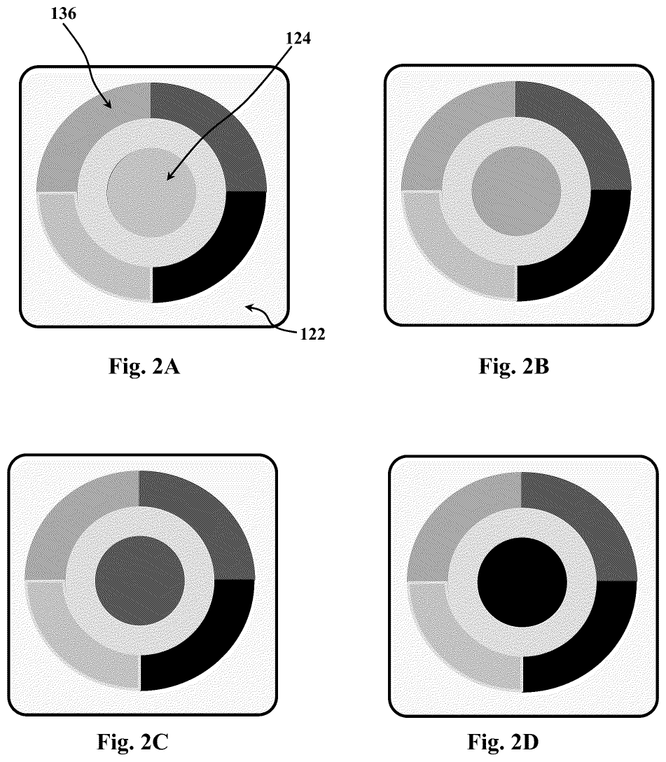

An exemplary TTI device at its various operational states is shown in FIGS. 2A-2D. In this example, the TTI device provides indication to the user about the time-temperature history of the perishable good by a visual observable change in the color of the active area of the TTI. Pressable section 124 is clear (or transparent) and therefore a user can view the change in color resulting from the advancement of the reaction between the first and second reactants (in this example between the etchant and the metal film). To permit accurate reading of the color, carrier layer 122 is printed with reference color blocks 136, such that the user can easily compare between the color developed beneath pressable section 124 and the reference colors 136, thus obtaining an indication of the usability of the perishable good. In this specific example, the color blocks 136 provide a graduated color index that matches the color development as a result of the reaction between the etchant and the metal. As can be seen, before activation (FIG. 2A), the color beneath pressable section 124 observable by the user is light. After activation, and depending on time and temperature, the color becomes darker (FIG. 2B-2C), until turning dark (FIG. 2D), indicating that the perishable good is no longer usable.

While in this specific example the physical change in the device is a color change from bright to dark, it is well understood that any other color change is encompassed by this disclosure (for example dark to bright, change of shade, change from one color to another, change in reflectance, appearance/disappearance of lettering, patterns, pictograms or signs, etc.).

Further, while in this example a plurality of reference color blocks is shown, it is to be understood that only a single-color block can be used. In some configurations, no reference color blocks are present and the change in color of the device may be identified without any comparison to a reference color.

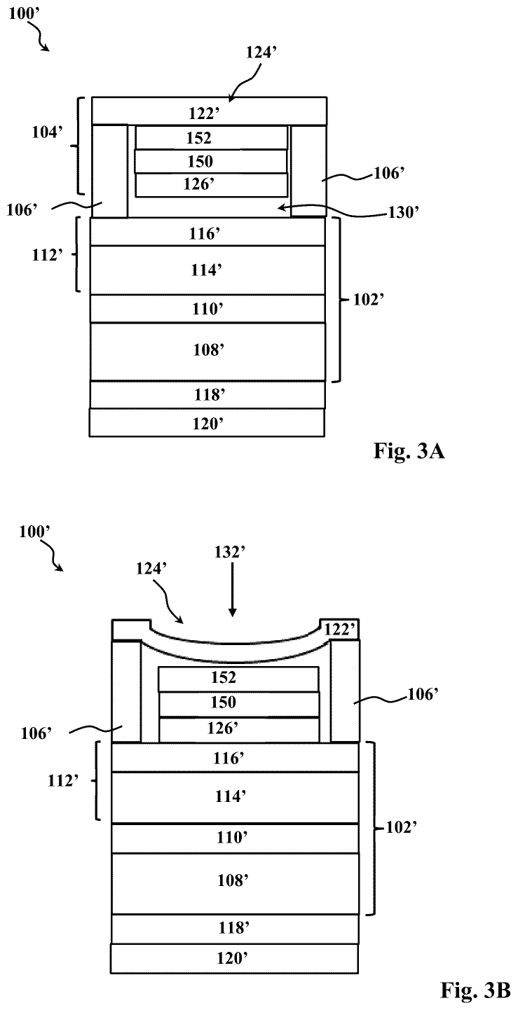

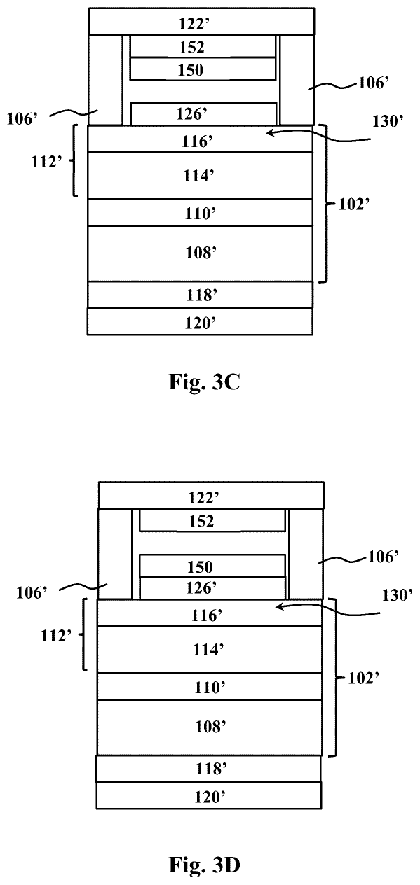

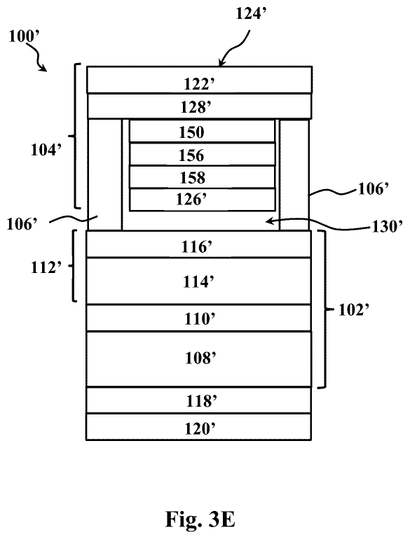

A variant of the exemplary configuration of FIGS. 1A-1C is shown in FIGS. 3A-3C (elements having the same function as those in FIGS. 1A-1C are marked in FIGS. 3A-3C with a “′” marking; the reader is directed to the description of FIGS. 1A-1C for full understanding of the functionality of such elements). In FIGS. 3A-3C, second reactant layer 126′ is an active adhesive (i.e. an adhesive comprising or constituting the second reactant) and is associated with carrier film 122′ through a release layer 150. The release layer 150 is bonded to the carrier film 122′ by an adhesive 152. Release layer 150 comprises or is made of a material that binds to the second reactant layer 126′ less effectively than the binding of the second reactant layer 126′ to metal film 116′. Hence, due to the difference in binding, bringing the second reactant layer 126′ into contact with the metal film 116′ by elastically deforming section 124′ will cause the second reactant layer 126′ to adhere to metal film 116′, and detach from release layer 150, as seen in FIG. 3C.

In the variation of FIG. 3D, the adhesion strength of adhesive 152 to release layer 150 is lower than the adhesion strength of second reactant layer 126′ to metal film 116′. Hence, once second reactant layer 126′ is adhered to metal film 116′, it detaches, together with release layer 150 from adhesive 152.

In the variation of FIG. 3E, second reactant layer 126′ (which is constituted by an active adhesive) is carried by film 158, which is attached to release layer 150 via lamination adhesive 156.

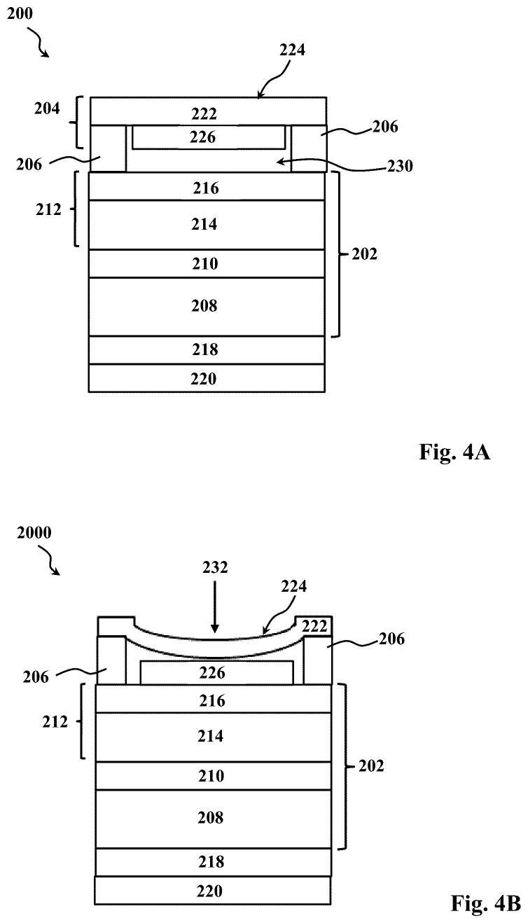

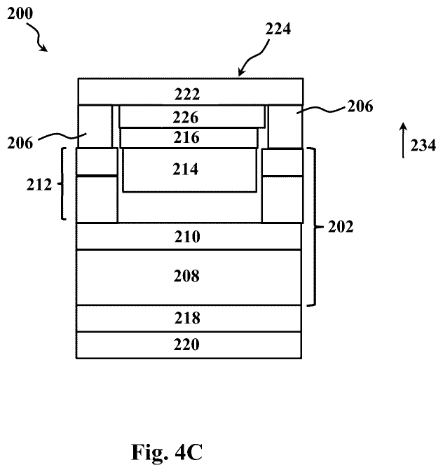

Another example is provided in FIGS. 4A-4C. TTI device 200 comprises first element 202 and second element 204, which are separated by a spacer 206. Similar to the device of FIGS. 1A-1C, first element 202 comprises substrate film 108, onto which a first reactant layer 212 is adhered by a first adhesive 210. First reactant layer 212 is a metalized polymeric film comprising polymeric film 214 and thin metal (e.g. aluminum) film 216. Substrate 208 is coated by package-attaching adhesive layer 218, which is covered by a user-removable protective release layer 220 to permit attachment of the device to the perishable good or to a packaging thereof.

Second element 204 comprises carrier film 222 that has a pressable section 224, which is attached to second reactant layer 226 (for example a pressure-sensitive adhesive matrix in which an etchant is dispersed). In this example, the presence of intermediate adhesive 228 is optional.

In FIG. 4A, the TTI device 200 is at its non-activated state, in which the first reactant layer 202 and the second reactant layer 204 are non-contacted and separated by spacer 206.

Similar to the example of FIG. 1A, a user applies force onto the pressable section 224 (represented by arrow 232 in FIG. 4B), in order to activate the device. Due to this force application, pressable section 224 is elastically deformed, causing the second reactant layer 226 to be displaced through hollow activation zone 230 towards the first reactant layer 212, and once contacted, the second reactant layer 226 (being or comprising an adhesive matrix) adheres to metal film 216.

In this example, the first adhesive 210 has a lower adhesion strength to film 214 than that of the adhesion strength of the adhesive constituting (or being part of) the second reactant layer 226 to metal film 216. Hence, once second reactant layer 226 is adhered to metal film 216, and pressable section 224 returns to its non-pressed state (in the direction of arrow 234) due to its elasticity, a portion of metal film 216 and polymeric film 214 detaches from the first adhesive 210 and is displaced upwards together with second reactant layer 226, and the TTI device is activated.

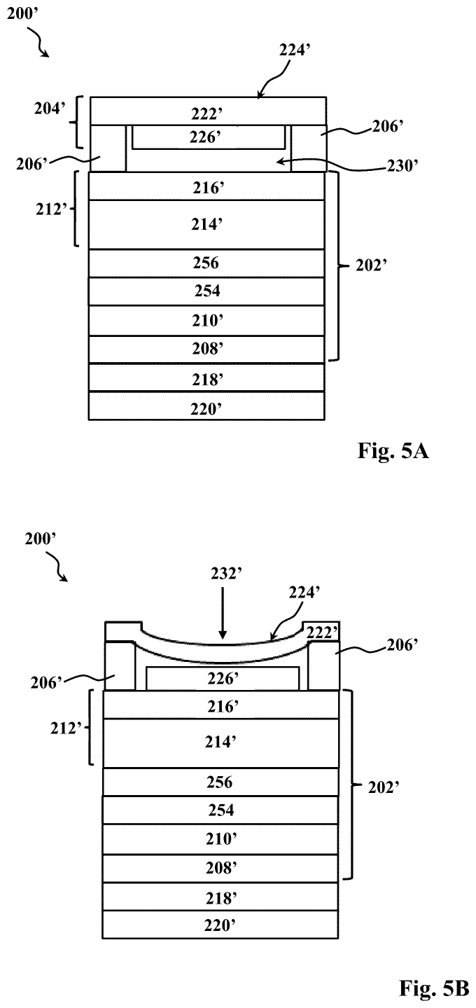

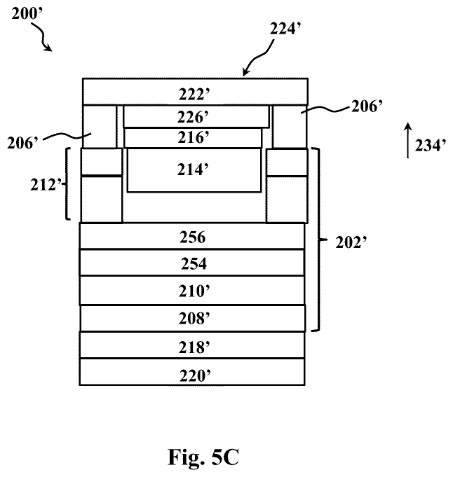

A variant of the exemplary configuration of FIGS. 4A-4C is shown in FIGS. 5A-5C (elements having the same function as those in FIGS. 4A-4C are marked in FIGS. 5A-5C with a “ ” marking; the reader is directed to the description of FIGS. 4A-4C for full understanding of the functionality of such elements). In FIGS. 5A-5C, the first reactant layer 212′ is associated with substrate film 208′ through a release layer 254. The release layer 254 is bonded to the substrate film 208′ by adhesive 210′ and to polymeric film 214′ via adhesive 256. Release layer 254 comprises or is made of a material that binds to the polymeric film 214′ less effectively than the binding of the second reactant layer 226′ to the metal film 216′. Hence, due to the difference in binding, bringing the second reactant layer 226′ into contact with metal film 216′ by elastically deforming section 224′ will cause the second reactant layer 226′ to adhere to the metal film 216′, and when the pressable section 224′ returns to its substantively non-pressed state—a position of the first reactant layer 212′ will detach from the release layer 254 and its associated adhesive 256.

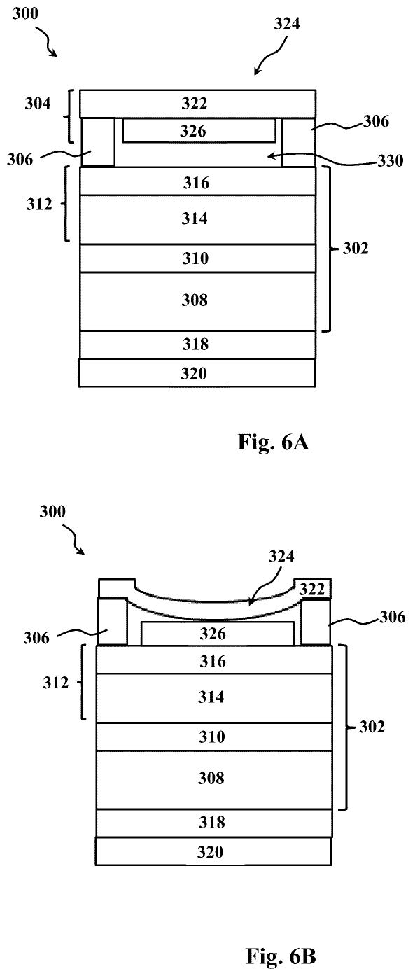

Another configuration of the TTI device is shown in FIGS. 6A-6B. In the device 300 shown in FIGS. 6A-6B, similar elements to those of FIGS. 1A-1C are included, shifted by 200. For example, spacer 306 in FIG. 3A has the same function as spacer 106 in FIG. 1A. Hence, the reader is referred to the description of FIG. 1A for a detailed description of the various functional elements.

Unlike the devices of FIGS. 1A-1C and 3A-5C, the TTI device 300 comprises the pressable section 324 that is plastically deformed when force is applied thereonto. Hence, once force is applied and removed, pressable section 324 does not return to its non-pressed state, and serves to further secure the adhered second reactant layer 326 and the first reactant layer 312 in position.

It is noted that in any of the variations of FIGS. 3A-6B, the same environmental protection configurations may be used as in the variants of FIGS. 1D-1E described above.

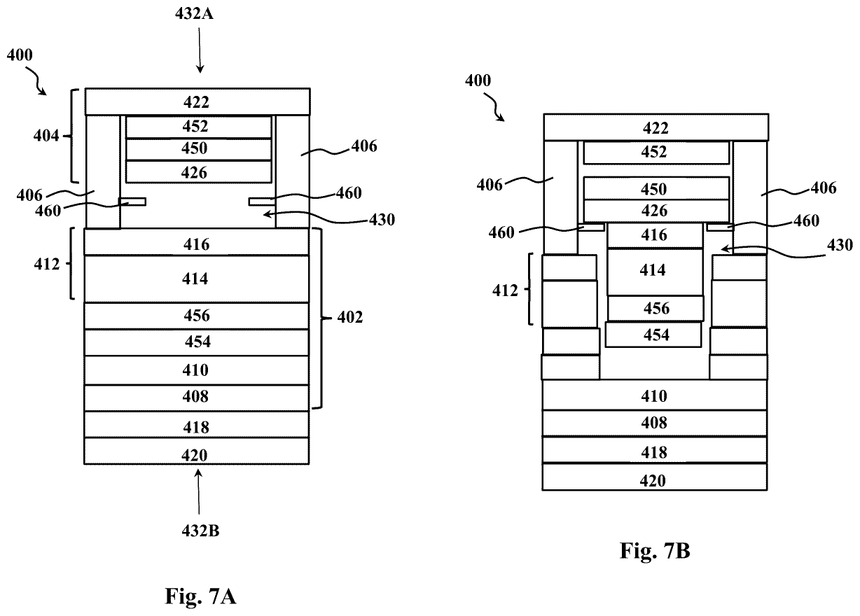

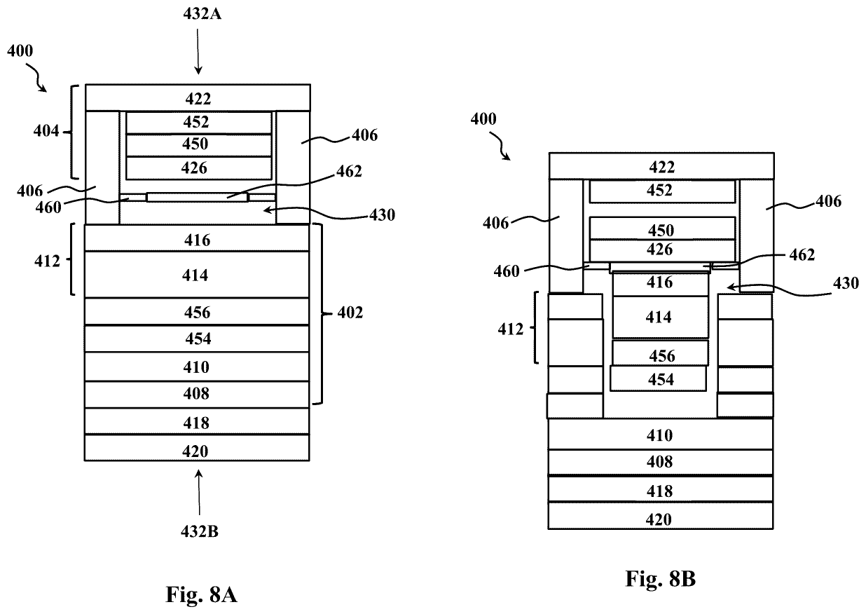

Another exemplary embodiment is shown in FIGS. 7A-7B. In the device 400 shown in FIGS. 8A-8B, similar elements to those of FIGS. 1A-1C are included, shifted by 300. For example, spacer 406 in FIG. 7A has the same function as spacer 106 in FIG. 1A. Hence, the reader is referred to the description of FIG. 1A for a detailed description of the various functional elements.

TTI device 400 comprises a first element 402 and a second element 404, separated by a spacer 406. Spacer 406 further comprises protrusions 460 that extend into hollow activation zone 430.

First element 402 comprises a substrate film 408, which is associated with first reactant layer 412 via release layer 454 (which is bonded to polymeric film 414 through adhesive 456). Second reactant layer 426, which is an adhesive that comprises or constitutes the second reactant, is attached to release layer 450, which is bonded carrier film 422 via adhesive 452 (as shown in FIG. 7A).

In this configuration, both the carrier film 422 and the first element 402 have pressable portions, such that when force is applied along oppositely directed arrows 432A and 432B, both the first element and the second element oppositely displace into hollow activation zone 430. In this embodiment, the second reactant layer 426 is larger than the opening defined between the protrusions 460, and hence will be arrested from further displacement within the hollow activation zone once contacting and binding to the protrusions 460. The first reactant layer 412 will be displaced in the direction of arrow 432B until a portion of metal film 416 contacts and adheres to second reactant layer 426. As the adhesion strength between the metal film 416 and the second reactant layer 426 is stronger than both the binding of adhesive 452 to the release layer 450 and from the adhesion strength of adhesive 410 to release layer 454—the second reactant layer 426 will detach together with release layer 450 from adhesive 452 and the portion of the first reactant layer 412 will detach together release layer 454 from adhesive 410 when the first and second elements return to their substantially non-pressed states (as shown in FIG. 7B).

Another variant of the configuration of FIGS. 7A-7B is shown in FIG. 8A-8B, with the only difference being the presence of membrane barrier member 462. Membrane barrier element 462 may be porous (or permeable) to the etchant contained in the second reactant layer 426 as to permit diffusion of the etchant through the membrane to cause etching of the metal film 416 when contacted. Alternatively, membrane barrier member 462 can be breakable or breachable upon application of force (e.g. along arrows 432A and/or 432B), such that once force is applied onto the device in order to bring the first and second reactant layers into contact with one another, such force is sufficient to break or breach the membrane barrier member 462 to permit contact between the etchant and the metal film.

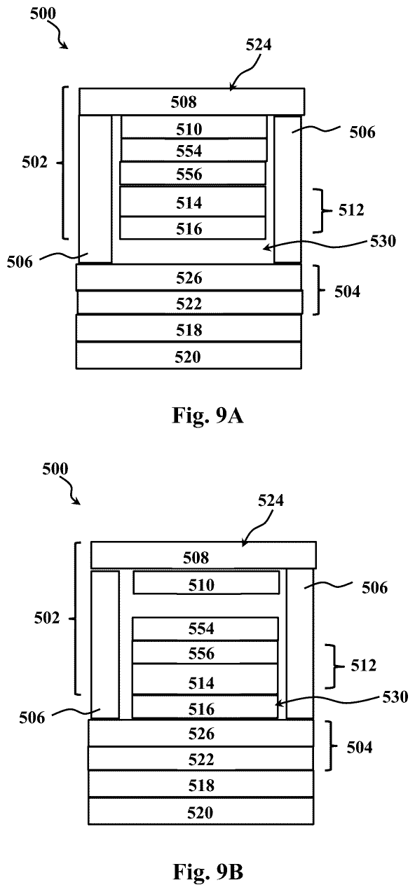

Another device is shown in FIGS. 9A-9B, in which the pressable section is part of the substate film of the first element rather than of the carrier film of the second element. In the device 500 shown in FIGS. 9A-9B, similar elements to those of FIGS. 1A-1C are included, shifted by 400. For example, spacer 506 in FIG. 9A has the same function as spacer 106 in FIG. 1A. Hence, the reader is referred to the description of FIG. 1A for a detailed description of the various functional elements.

As can be seen, in the device 500, first element 502 has a pressable section 524, which can be pressed to displace the first reactant layer 512 into hollow reaction zone 530 towards second reactant layer 526. First reactant layer 512 is adhered to release layer 554 via adhesive 556; while release layer 554 is adhered to substrate film 508 via adhesive 510. As the adhesion strength between the active adhesive constituting second reactant layer 526 and metal layer 516 is stronger than the adhesion strength between adhesive 510 and release layer 554—once the first and second reactant layers are attached to one another by pressing onto pressable section 524, metal film 516 (together with polymeric film 514 and release layer 554) will detach from the substrate 508.

1. A time-temperature indication (TTI) device, comprising:
a first element comprising a substrate film carrying a first reactant layer;
a second element comprising a carrier film having at least one pressable section, said pressable section carrying a second reactant layer on at least a portion thereof, the second reactant layer configured to adhere to the first reactant layer;
a spacer configured to separate between the first element and the second element, and having a hollow activation zone substantially aligned with said at least one pressable section;
the device having a non-activated state, in which the first reactant layer and the second reactant layer are non-contacted,
and an activated state, in which said second reactant layer is adhered to at least a portion of said first reactant layer to enable a reaction therebetween that causes at least one substantially irreversible change in physical property of the device, said reaction being indicative to time-temperature history of the device,
the device being switchable from the non-activated state to the activated state by displacing the pressable section into the hollow activation zone towards said first element to cause adhering of the second reactant layer to the first reactant layer.

2. The TTI device of claim 1, wherein the pressable section is plastically deformable or elastically deformable.

3. (canceled)

4. The TTI of claim 1, wherein one or both of the first reactant layer and the second reactant layer is detachable from the substrate film and the carrier film, respectively, to permit detachment of said first reactant layer and/or second reactant layer from said substrate film and carrier film, respectively, after adherence of the second reactant layer to the first reactant layer.

5. The TTI device of claim 1, wherein the first reactant layer is detachable from the substrate film, such that adherence to the second reactant layer detaches at least a portion of the first reactant layer from the substrate film.

6. The TTI device of claim 1, wherein the first reactant layer is attached to the substrate film by a first adhesive and the second reactant layer comprises a second adhesive in which the second reactant is embedded or dispersed, the first adhesive having a lower adhesion strength to the substrate film than the adhesion strength of the second adhesive to the first reactant layer.

7. (canceled)

8. (canceled)

9. (canceled)

10. (canceled)

11. The TTI device of claim 1, wherein at least a portion of the first element is deformable or pressable, and said hollow activation zone is configured to accommodate displacement of at least a portion of the first reactant layer thereinto.

12. (canceled)

13. The TTI device of claim 1, wherein the first reactant layer-comprises a metal-containing sub-layer.

14. The TTI device of claim 13, wherein said metal-containing sub-layer is in the form of metal particles embedded in a polymeric matrix.

15. (canceled)

16. (canceled)

17. (canceled)

18. (canceled)

19. (canceled)

20. (canceled)

21. (canceled)

22. (canceled)

23. (canceled)

24. The TTI device of claim 1, wherein the pressable section of the carrier film is clear, transparent, or semi-transparent.

25. (canceled)

26. (canceled)

27. The TTI device of claim 1, wherein the carrier film is coated by a protective coating.

28. (canceled)

29. The TTI device of claim 1, encapsulated by one or more encapsulation layers.

30. The TTI device of claim 1, wherein said physical property is selected from at least one of color, transparency, electric conductivity, reflectance, volume and fluidity.

31. The TTI device of claim 1, wherein the first element is configured for attachment to a surface of an article.

32. (canceled)

33. (canceled)

34. (canceled)

35. (canceled)

36. (canceled)

37. An article of manufacture comprising one or more time-temperature indication (TTI) device of claim 1.

38. The article of claim 37, being a perishable good and/or a packaging of a perishable good.

39. A method of activating a time-temperature indication (TTI) device, the method comprising:
displacing a pressable section of a carrier film of a second element of the TTI device towards a first reactant layer of a first element of the TTI device, the pressable section carrying a second reactant layer on at least a portion thereof which is configured to adhere to the first reactant layer, said displacing being through a hollow activation zone that is substantially aligned with said at least one pressable section and being defined in a spacer configured to separate between the first element and the second element, and said displacing causing adhering of the second reactant layer to the first reactant layer to activate a reaction therebetween, the reaction causing at least one substantially irreversible change in physical property of the device that is indicative to time-temperature history of the device.

40. The method of claim 39, further comprising displacing at least a portion of the first reactant layer into the hollow activation zone towards the second reactant layer.

41. The method of claim 40, wherein displacing said portion of the first reactant layer into the hollow activation zone is carried out concomitantly with pressing of the pressable section of the second element.

42. The method of claim 39, wherein one or both of the first reactant layer and the second reactant layer are detachable from the substrate film and the carrier film, respectively, to permit detachment of said first reactant layer and/or second reactant layer from said substrate film and carrier film, respectively, after adherence of the second reactant layer to the first reactant layer.

43. (canceled)

44. (canceled)

45. (canceled)

46. (canceled)

47. An indication device, comprising:
a first element comprising a substrate film carrying a first reactant layer;
a second element comprising a carrier film having at least one pressable section, said pressable section carrying a second reactant layer on at least a portion thereof, the second reactant layer configured to adhere to the first reactant layer;
a spacer configured to separate between the first element and the second element, and having a hollow activation zone substantially aligned with said at least one pressable section;
the device having a non-activated state, in which the first reactant layer and the second reactant layer are non-contacted,
and an activated state, in which said second reactant layer is adhered to at least a portion of said first reactant layer to enable a reaction therebetween that causes at least one substantially irreversible change in physical property of the device,
the device being switchable from the non-activated state to the activated state by displacing the pressable section into the hollow activation zone towards said first element to cause adhering of the second reactant layer to the first reactant layer,
the reaction being indicative to time-temperature history, temperature history, or time history of the device.
